(19) United States
(12) Patent Application Publication
(10) Pub. No.: US 2018/0330387 A1
(43) Pub. Date: Nov. 15, 2018

(54) GROUP BUYING ONLINE AD CAMPAIGNS

(71) Applicant: GOOGLE INC., Mountain View, CA (US)

(72) Inventors: Christopher Kenneth Harris, Santa Clara, CA (US); Xiaofeng Guo, Fremont, CA (US); Ke Huang, Sunnyvale, CA (US); Bahman Rabii, San Francisco, CA (US); Alok Goel, Mountain View, CA (US)

(73) Assignee: GOOGLE INC., Mountain View, CA (US)

(21) Appl. No.: 13/673,906

(22) Filed: Nov. 9, 2012

(51) Int. Cl. G06Q 30/02; G06Q 10/08; G06Q 30/06

(52) U.S. Cl. CPC G06Q 30/02; G06Q 30/06; G06Q 10/08

(57) ABSTRACT

Conducting a group buying advertising campaign. Receiving a specification for a group-buying offer. Creating a candidate ad campaign based on the received specification. The candidate ad campaign includes at least one campaign feature. The candidate ad is characterized by at least one generalized feature. Determining the expected effectiveness of the candidate ad campaign. For an expected effectiveness less than the aggregate effectiveness of a set of at least one previously run ad campaigns having a generalized feature in common with the candidate campaign, editing the candidate ad campaign to incorporate at least one feature of the set of at least one previously run ad campaigns. Running the edited ad campaign in an ad display network. Collecting effectiveness data for each run ad campaign.

### TECHNICAL FIELD

Embodiments of the present technology relate generally to electronic commerce, and more specifically to ad campaigns for online group buying.

### BACKGROUND

In “group buying,” a product or service (hereinafter referred to as “product”) may be offered under favorable terms (e.g., at a reduced price, with free delivery) on the condition that a minimum number of consumers, and in some cases a maximum number of consumer, agree to purchase the product. Online group buying may be practiced through a group buying intermediary such as a group buying service.

### SUMMARY

The technology of the present disclosure includes computer-implemented methods, computer program products, and systems for conducting group buying advertising. In such embodiments, a specification for a group-buying offer is received. A candidate ad campaign is created based on the received specification. The candidate ad campaign includes at least one campaign feature, and characterized is characterized by at least one generalized feature. An expected effectiveness of the candidate ad campaign is determined. For an expected effectiveness less than the aggregate effectiveness of a set of at least one previously run ad campaigns having a generalized feature in common with the candidate campaign, the candidate ad campaign is edited to incorporate at least one feature of the set of at least one previously run ad campaigns. The edited ad campaign is run in an ad display network, and effectiveness data for each run ad campaign is collected.

### BRIEF DESCRIPTION OF THE DRAWINGS

FIG. 1 illustrates an architecture for example embodiments of the present technology.

FIG. 2 is a block flow diagram depicting a method for conducting group buying ad campaigns, in accordance with certain example embodiments.

FIG. 3 is a block flow diagram depicting portions of a method for conducting group buying ad campaigns, in accordance with certain example embodiments.

FIG. 4 is a block flow diagram depicting portions of a method for conducting group buying ad campaigns, in accordance with certain example embodiments.

FIG. 5 is a block flow diagram depicting portions of a method for conducting group buying ad campaigns, in accordance with certain example embodiments.

FIG. 6 is a block flow diagram depicting portions of a method for conducting group buying ad campaigns, in accordance with certain example embodiments.

FIG. 7 is a block diagram depicting a computing machine and a module, in accordance with certain example embodiments.

### DETAILED DESCRIPTION

### Overview

In a typical online group buying business model, the intermediary may enlist subscribers, and may solicit personalized information about each subscriber. The intermediary, which may be the product provider, may send a daily e-mail message (or in some cases other message forms such a postal message or an instant message) to certain subscribers containing a group buying offer, for example, a “deal-of-the-day” or a “daily offer.” A group buying offer may be provided to certain subscribers based on personalized information accessible to the intermediary. Often, the group buying offer may be provided to subscribers in a focused geographic area for a single day. Typically, a purchased offer is not required to be used on the day of purchase, but there may be a limited period during which a purchased offer may be redeemed.

A subscriber may sign up for an offer, for example, by clicking through a link in a daily offer e-mail message. A landing page associated with the link may be loaded into a web browser on the subscriber's computing machine (or as applicable, a window in a native application, for example, a native application on a mobile communication device such as a smartphone or a tablet computer). A subscriber may accept the offer.

When an offer condition is met, for example, a minimum number of subscribers have signed up for the offer, those subscribers that have signed up may be charged for purchasing the offer, and a receipt/coupon for redeeming the offer may be send to purchasing subscribers. Subsequent subscribers may then purchase the offer. In some cases, an offer purchase termination condition may be established for an offer, for example, an upper limit on the number of products to be sold under the offer. Offers other than the daily offer typically are available on the intermediary's web site, under similar conditions as daily offers

Group buying intermediaries may advertise for subscribers online on “partner sites” such as search engines results pages, certain web applications (such as within a web e-mail service), and content web sites (such as a video community). A collection of such pages and applications can be referred to as an “ad display network.”

As noted above, group buying intermediaries may advertise for subscribers on partner sites. But traditionally, intermediaries do not directly advertise specific group buying offers outside of the subscriber base or on display networks. This approach can result, among other things, in limiting the intermediary to its subscriber base. Potential customers outside the subscribe base may be receptive to learning about group buying offers, but may not be receptive to receiving e-mail from the intermediary. In addition, creating an ad campaign in an ad display network is mostly a manual ad-by-ad task. This situation creates a high per-ad-campaign transaction cost, making it prohibitive for an intermediary to timely place enough single group buying offer ads in an ad display network at a manageable cost. Further, some potential customers may be turned off by having to subscribe to multiple online group buying sites in order to cover the range of group buying offers in the potential customer's geographic area.

Instead of running an online ad campaign to solicit subscribers, embodiments of the present technology can automatically, using one or more computing devices, create, run, and monitor an ad campaign directed to methods other than e-mail for delivering online ads for individual group buying offers. The methods other than e-mail can include displaying ads for group buying offers through online ad display networks, for example, networks that display ads on search engine results pages, within web applications, and on content web sites.

### Example Systems

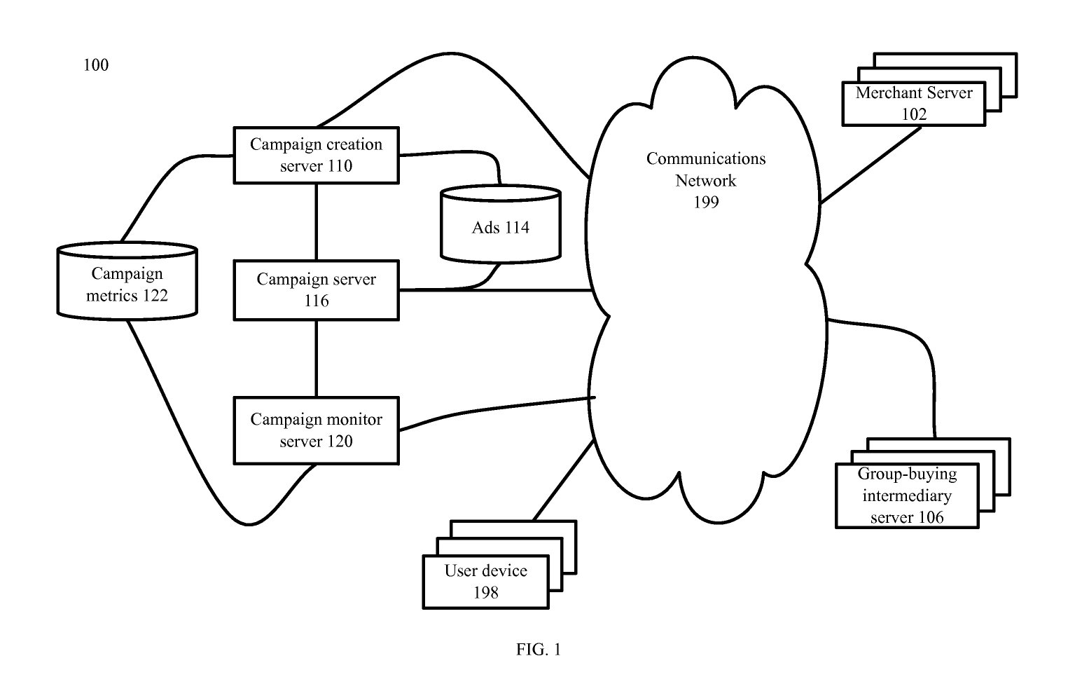

FIG. 1 illustrates an architecture 100 for embodiments of the present technology. In the illustrated architecture 100, communication between elements can be provided by communications network 199. The communications network 199 may include wired and wireless telecommunication means by which elements of the architecture 100 may exchange data. For example, the network 199 may include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment. It will be appreciated that the network connections shown are example and other means of establishing a communications link between elements of the architecture may be used.

In the illustrated architecture 100, each of one or more merchant servers 102 may provide data for one or more group buying offers to a group buying intermediary server 106. The group buying intermediary server 106 may prepare a group buying offer specification from the data and provide the group buying offer specification to a campaign creation server 110. The group buying intermediary also may operate a typical group buying program via the group buying intermediary server 106.

Upon receiving a group buying offer specification, the campaign creation server 110 can automatically create a group buying offer ad campaign, including, for each campaign, one or more ads 114 and a campaign specification. The campaign creation server 110 can determine the expected effectiveness of created ad campaigns (as described elsewhere herein).

A campaign server 116 can automatically run the campaign based on the campaign specification and the ads 114 corresponding to the particular campaign. For example, the campaign server 116 can distribute ads to one or more user devices 198 when prompted by a web search server. The campaign monitor server 120 can collect data on group buying offer ad campaigns, including data on group buying offer ad campaign effectiveness. Effectiveness data can include click-through rate, lead generation count, response rate, incremental sales, return on investment, requests for information, engagement with content, ad impressions, and measures derived therefrom. The effectiveness of a group of ads can be abstracted as an aggregate effectiveness through use of statistical measures such as mean, average, and median.

The campaign monitor server 120 can collect campaign data and derive campaign metrics 122, such as campaign effectiveness, from the collected campaign data. Metrics can include conversion rate, click count, and other data that are indicative of the effectiveness of each monitored ad and ad campaign. The metrics, and the campaign data can be sortable by generalized features. Generalized features include features common to grouping of ads, such as ad category (for example, Italian restaurant), ad geographic focus, and ad keywords. In some embodiments, the campaign monitor server 120 can identify those features of monitored performance that can serve as generalized features, for example by performing machine learning strategies such as cluster analysis on the monitored data. Identifying generalized features that more accurately represent the offer issuer space (or that provide a diverse set of views into the offer issuer space) can facilitate recommendation of daily offer features that will contribute to the effectiveness of an offer campaign.

The campaign creation server 110, in creation of ad campaigns, can use campaign metrics 122. For example, consider effectiveness data collected on previously run group buying ads that shows that Italian restaurant (generalized feature) daily offers have a high conversion rate if the restaurant is within five (5) miles of the user device (feature), and a substantially lower conversion rate outside that radius. If the expected conversion rate of a candidate ad campaign lacking this geographical focus is low, the technology can edit the candidate ad for a daily offer from an Italian restaurant (a generalized feature in common with ad campaigns that have already run) to be provided to user devices known or suspected to be within five (5) miles of the restaurant (a feature of those previously-run ads). Such campaign feature is referred to as a geographical focus.

Such process, for example, recommending ad campaign features that are changes or additions to the group buying offer specification, is referred to herein as “optimization.” Campaign features generally, including ad budget, ad bidding specification, and keyword inclusion can be recommended in this fashion to facilitate optimizing an ad campaign. Identification of features to optimize can be implemented through machine learning processes.

### Example Processes

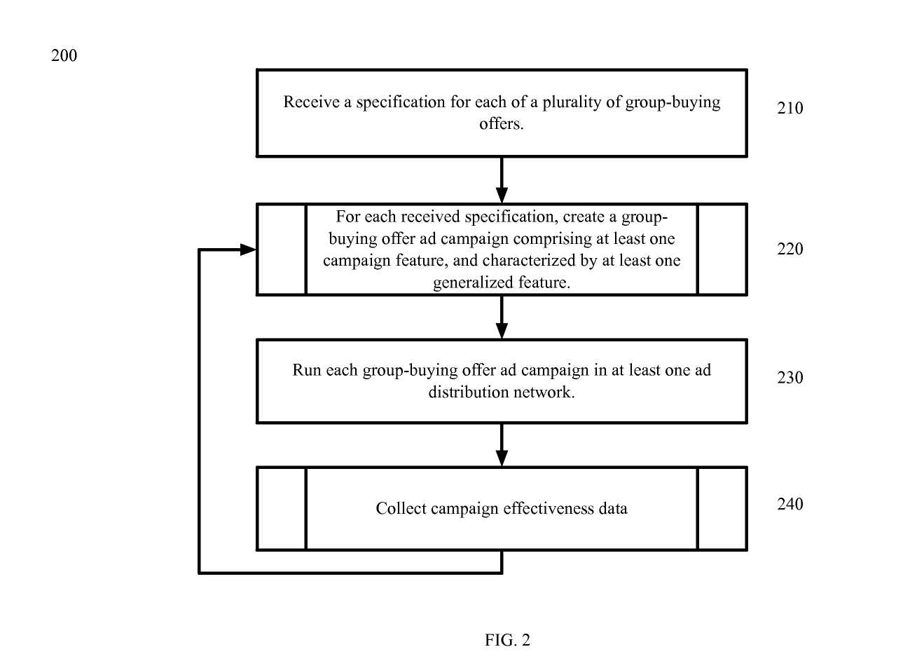

Referring to FIG. 2, methods 200 for conducting group buying advertisement are illustrated. In such methods, the technology can receive a specification for each of a number of individual group buying offers —210. The specification will include a description of the offering business. For example, the specification may identify the offering business as a restaurant, and identify one or more locations of the restaurant. The specification will include a description of the offer, including the product offered, the price, and the dates for which the offer is valid, and restrictions on redemption of the offer. For each received group buying offer specification, the technology can create a group buying offer ad campaign —220. The ad campaign can include at least one ad, and can be characterized by features including at least one generalized feature. For example, a business may be characterized by generalized features such as “restaurant,” “10-50 seats,” and “$20-$50 entrees.” Ad creation can be implemented through the use of various formulas, rules, and heuristics.

Each group buying offer ad campaign can be run in at least one distribution network —230. For example, on a shopping web site that it participating in an ad distribution network as part of the architecture of embodiments of the present technology, a user may submit a query for “spark plugs.” The shopping web site server may communicate the query to an ad campaign server of embodiments of the present technology. The ad campaign server can then present a group-buying offer for auto tune-up services as a display ad on the results page presented to the user on the user's device in response to the “spark plugs” query.

Embodiments of the technology can collect campaign effectiveness data the campaign that was run —240. As used herein, collecting campaign effectiveness data can include receiving campaign effectiveness data from other technologies. Effectiveness data can include click-through rate, lead generation count, response rate, incremental sales, return on investment, requests for information, engagement with content, ad impressions, and measures derived therefrom. The effectiveness of a group of ads can be abstracted as an aggregate effectiveness through use of statistical measures such as mean, average, and median. The campaign effectiveness data, and measures of effectiveness abstracted therefrom, can used in determining the expected effectiveness of future campaigns of businesses having similar generalized features, and can be used to improve the effectiveness of an exiting campaign.

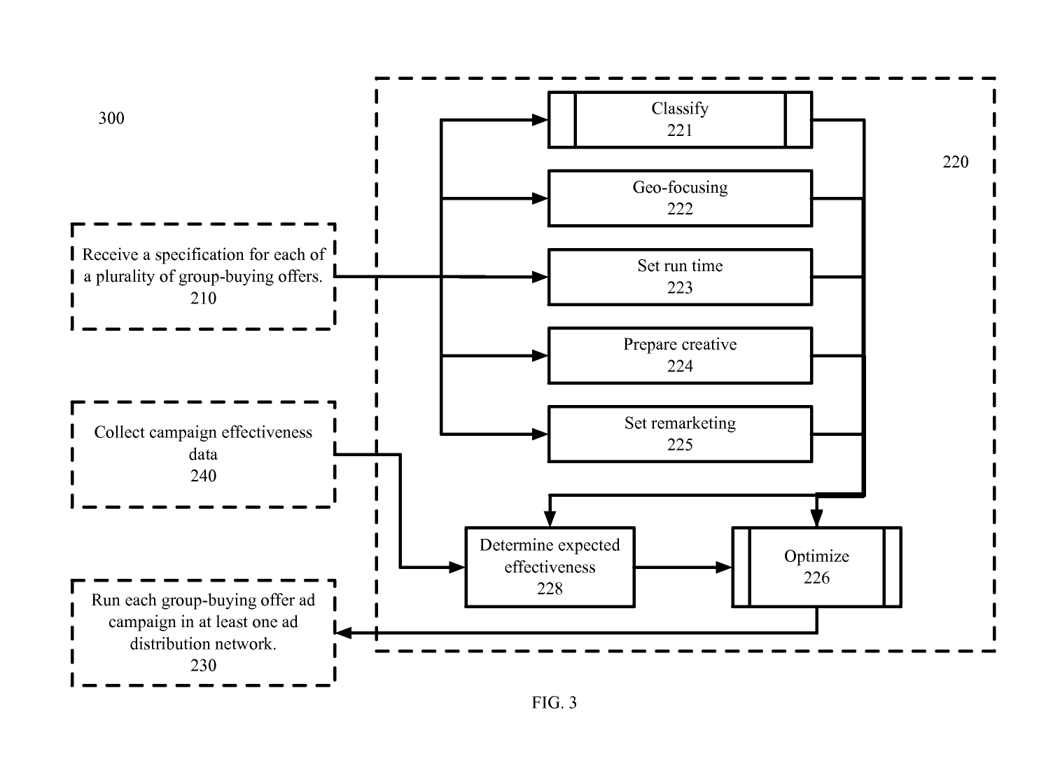

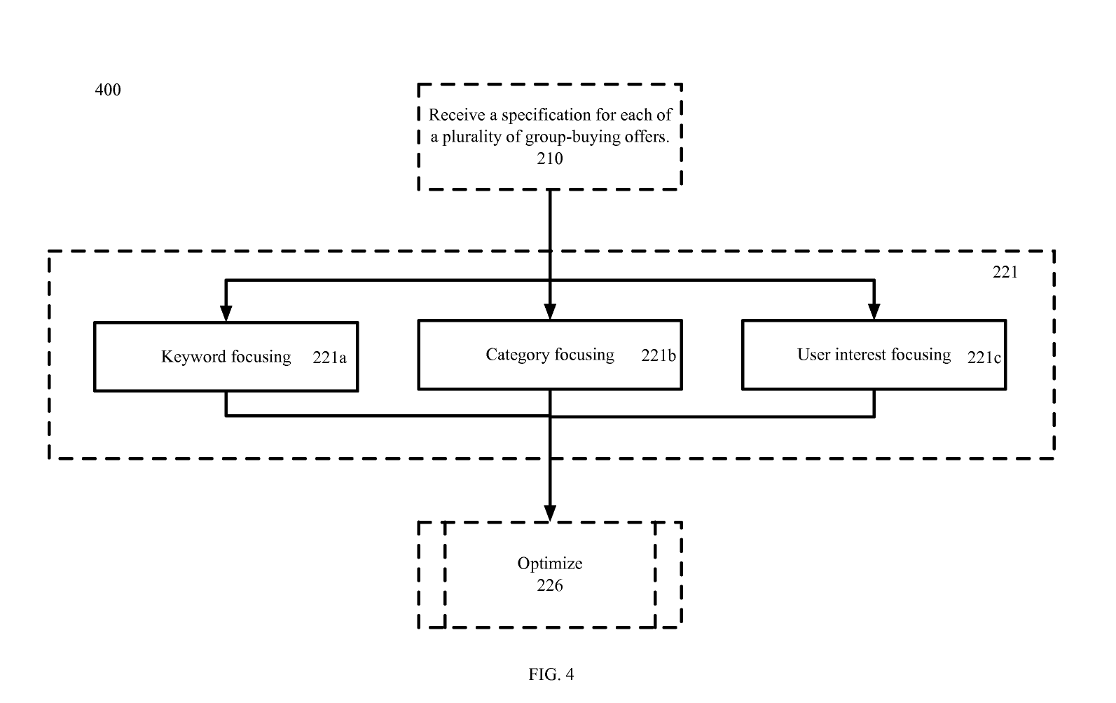

Referring to FIG. 3, details of creating a group buying offer ad campaign 220 are shown in the context of the steps of FIG. 2, though creation of a group buying offer ad campaign of the present technology is not limited to this context. Upon receiving a specification for a group buying offer, the technology can classify 221 the offer in various ways. As examples, FIG. 4 presents details 400 of three ways classifying 221 the data of a received ad specification: keyword focusing 221a, category focusing 221b, and user interest focusing 221c.

Further, embodiments of the technology can create the ad to focus on a specific geographic area —222. For example, the technology can create the ad to focus an offer for state automotive inspection on devices expected to be associated with users known or suspected to own a vehicle registered in the particular state. As a further example, the technology can focus an ad for lunch specials at a downtown restaurant on devices known or suspected to be within short walking distance of the restaurant.

Some embodiments of the technology can set the run time 223 of the ad campaign as part of creating the ad campaign from a specification of the group buying offer. For example, an ad campaign created for a downtown lunch special as described herein can have a run time of 11:30 a.m. until 12:00 p.m. and 1:00 p.m. until 3:00 p.m. on weekdays. Embodiments of the technology can prepare ad campaign creatives 224 of the ad campaign as part of creating the ad campaign from a specification of the group buying offer. Ad campaign creative include the entire expressive content of the campaign, including, but not limited to, images, font, wording (“½ off” versus “half off” versus “50% off”), and spatial arrangement. Remarketing parameters of the ad campaign also can be set by embodiments of the technology. Remarketing allows a group buying offer to show ads when a user device visits sites in an ad display network other than the site at which the ad was originally displayed via the device during a campaign. For example, when a user clicks through a group buying offer to a site of the intermediary, and then navigates away from the intermediary's site to a third web site without purchasing the offered product, remarketing can display an ad of the campaign on the third site that may encourage the user to return to the intermediary's site and complete a purchase.

Embodiments of the technology also can determine the expected effectiveness of a candidate ad campaign 240 using campaign effectiveness data from businesses having the same or similar general features. In some embodiments, the technology can determine the expected effectiveness of a candidate ad campaign using campaign effectiveness data related to the same or similar products, and using data from the same or similar offers. A candidate ad campaign and its expected effectiveness can be used to optimize the candidate ad campaign. An optimized ad campaign can be run in an ad distribution network as described elsewhere herein.

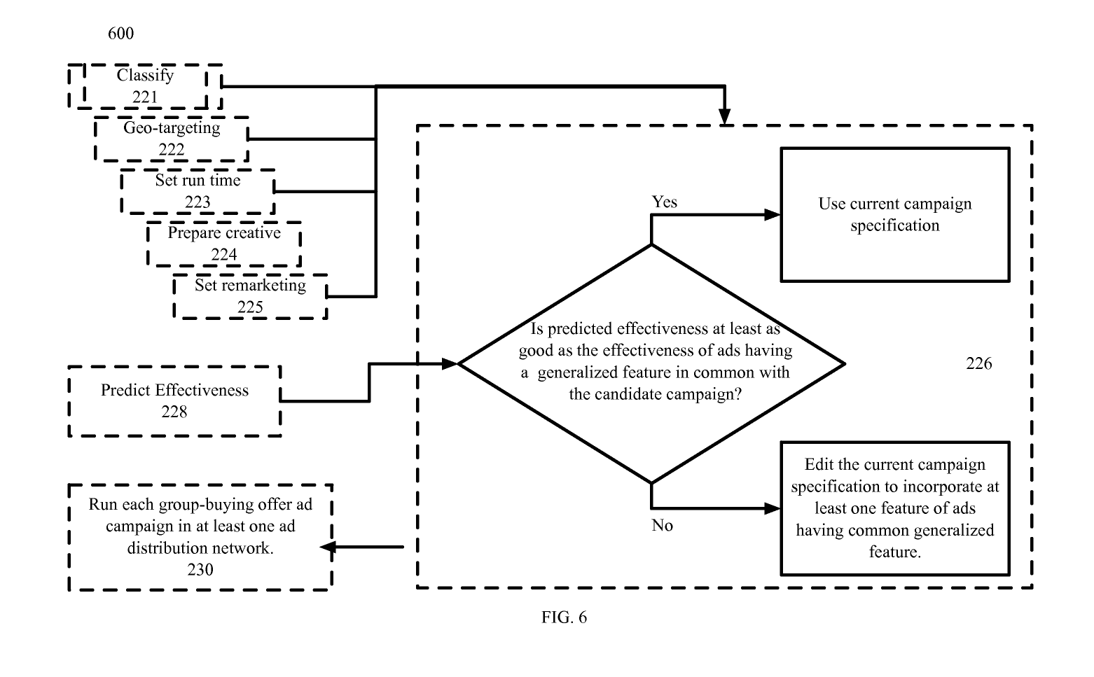

Referring to FIG. 6, details 600 of ad campaign optimization 226 of certain embodiments of the present technology are shown. In such embodiments, an expected effectiveness of a candidate ad campaign is compared to the effectiveness of ad campaigns from businesses having similar generalized features —226a. If the expected effectiveness is at least as good as the effectiveness of the compared campaigns, then the candidate campaign is used —226b. If not, then the candidate ad campaign is edited with at least one feature of the compared campaigns 226c, and the comparison is run at least one more time. In some embodiments, the collection of ad campaign features providing the most favorable effectiveness data is used to run the ad campaign 230 as described elsewhere herein.

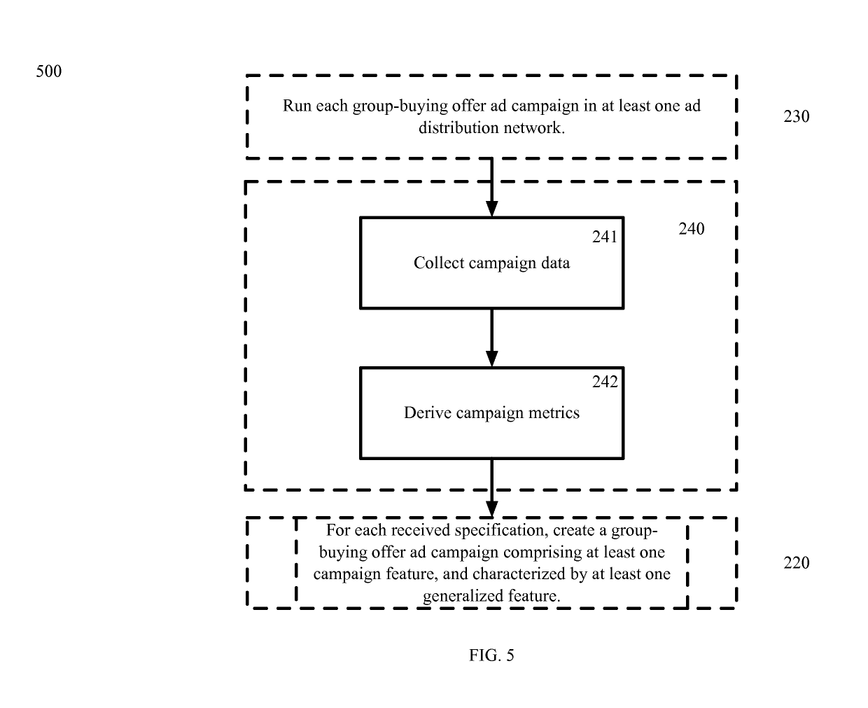

Referring to FIG. 5, details 500 of collecting ad campaign effectiveness data 240 of certain embodiments of the present technology are shown. As a group buying offer ad campaign is run in an ad distribution network, campaign data can be collected 241. Campaign effectiveness metrics can be derived 242 from the collected campaign data. For example, with the proper permissions, campaign data can be collected on the number of offer impressions, and on the amount of sales during the offer period. With access to regular sales during comparative periods, the technology can determine the change in sales of products covered by the offer during the offer period per impression versus regular sales of the product during a comparative period. In some embodiments of the technology the system can receive input on the particular one or more effectiveness parameters to optimize on, and use those parameters for optimization.

In some embodiments, the received group-buying offer specification can include one or more of a candidate classification, candidate geographic focusing, candidate run time, candidate creative content, and candidate remarketing parameters. In such embodiments, the technology can proceed directly to optimization, or can independently create a second candidate advertising campaign that can then be optimized in conjunction with the received candidate advertising campaign.

### Other Example Embodiments

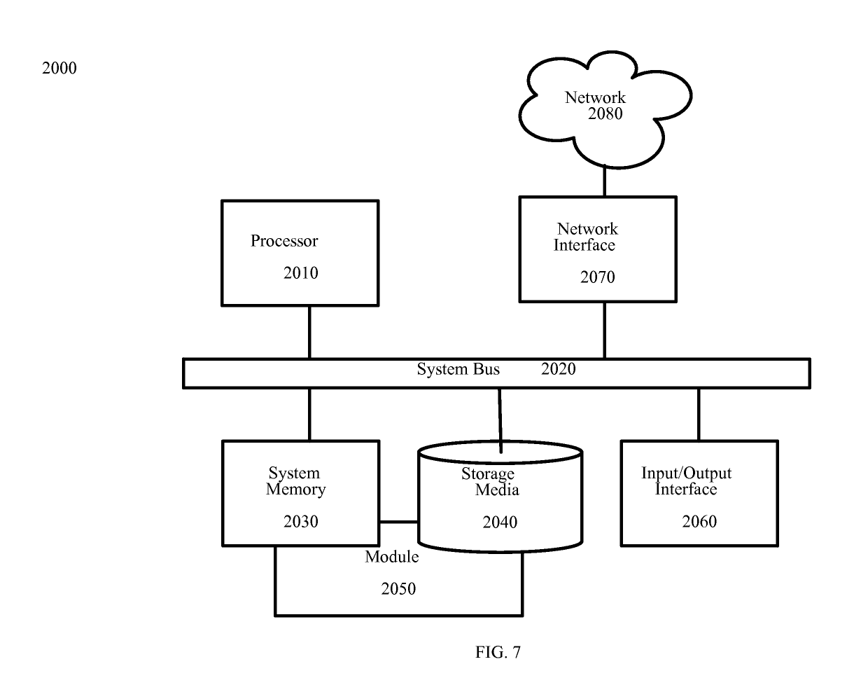

FIG. 7 depicts a computing machine 700 and a module 750 in accordance with certain example embodiments. The computing machine 700 may correspond to any of the various computers, servers, mobile devices, embedded systems, or computing systems presented herein. The module 750 may comprise one or more hardware or software elements configured to facilitate the computing machine 700 in performing the various methods and processing functions presented herein. The computing machine 700 may include various internal or attached components such as a processor 710, system bus 720, system memory 730, storage media 740, input/output interface 760, and a network interface 770 for communicating with a network 780.

The computing machine 700 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 700 may be a distributed system configured to function using multiple computing machines interconnected via a data network or bus system.

The processor 710 may be configured to execute code or instructions to perform the operations and functionality described herein, manage request flow and address mappings, and to perform calculations and generate commands. The processor 710 may be configured to monitor and control the operation of the components in the computing machine 700. The processor 710 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 710 may be a single processing unit, multiple processing units, a single processing core, multiple processing cores, special purpose processing cores, co-processors, or any combination thereof. According to certain embodiments, the processor 710 along with other components of the computing machine 700 may be a virtualized computing machine executing within one or more other computing machines.

The system memory 730 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 730 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 730. The system memory 730 may be implemented using a single memory module or multiple memory modules. While the system memory 730 is depicted as being part of the computing machine 700, one skilled in the art will recognize that the system memory 730 may be separate from the computing machine 700 without departing from the scope of the subject technology. It should also be appreciated that the system memory 730 may include, or operate in conjunction with, a non-volatile storage device such as the storage media 740.

The storage media 740 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 740 may store one or more operating systems, application programs and program modules such as module 750, data, or any other information. The storage media 740 may be part of, or connected to, the computing machine 700. The storage media 740 may also be part of one or more other computing machines that are in communication with the computing machine 700 such as servers, database servers, cloud storage, network attached storage, and so forth.

The module 750 may comprise one or more hardware or software elements configured to facilitate the computing machine 700 with performing the various methods and processing functions presented herein. The module 750 may include one or more sequences of instructions stored as software or firmware in association with the system memory 730, the storage media 740, or both. The storage media 740 may therefore represent examples of machine or computer readable media on which instructions or code may be stored for execution by the processor 710. Machine or computer readable media may generally refer to any medium or media used to provide instructions to the processor 710. Such machine or computer readable media associated with the module 750 may comprise a computer software product. It should be appreciated that a computer software product comprising the module 750 may also be associated with one or more processes or methods for delivering the module 750 to the computing machine 700 via the network 780, any signal-bearing medium, or any other communication or delivery technology. The module 750 may also comprise hardware circuits or information for configuring hardware circuits such as microcode or configuration information for an FPGA or other PLD.

The input/output (“I/O”) interface 760 may be configured to couple to one or more external devices, to receive data from the one or more external devices, and to send data to the one or more external devices. Such external devices along with the various internal devices may also be known as peripheral devices. The I/O interface 760 may include both electrical and physical connections for operably coupling the various peripheral devices to the computing machine 700 or the processor 710. The I/O interface 760 may be configured to communicate data, addresses, and control signals between the peripheral devices, the computing machine 700, or the processor 710. The I/O interface 760 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 760 may be configured to implement only one interface or bus technology. Alternatively, the I/O interface 760 may be configured to implement multiple interfaces or bus technologies. The I/O interface 760 may be configured as part of, all of, or to operate in conjunction with, the system bus 720. The I/O interface 760 may include one or more buffers for buffering transmissions between one or more external devices, internal devices, the computing machine 700, or the processor 710.

The I/O interface 760 may couple the computing machine 700 to various input devices including mice, touch-screens, scanners, biometric readers, electronic digitizers, sensors, receivers, touchpads, trackballs, cameras, microphones, keyboards, any other pointing devices, or any combinations thereof. The I/O interface 760 may couple the computing machine 700 to various output devices including video displays, speakers, printers, projectors, tactile feedback devices, automation control, robotic components, actuators, motors, fans, solenoids, valves, pumps, transmitters, signal emitters, lights, and so forth.

The computing machine 700 may operate in a networked environment using logical connections through the network interface 770 to one or more other systems or computing machines across the network 780. The network 780 may include wide area networks (WAN), local area networks (LAN), intranets, the Internet, wireless access networks, wired networks, mobile networks, telephone networks, optical networks, or combinations thereof. The network 780 may be packet switched, circuit switched, of any topology, and may use any communication protocol. Communication links within the network 780 may involve various digital or an analog communication media such as fiber optic cables, free-space optics, waveguides, electrical conductors, wireless links, antennas, radio-frequency communications, and so forth.

The processor 710 may be connected to the other elements of the computing machine 700 or the various peripherals discussed herein through the system bus 720. It should be appreciated that the system bus 720 may be within the processor 710, outside the processor 710, or both. According to some embodiments, any of the processor 710, the other elements of the computing machine 700, or the various peripherals discussed herein may be integrated into a single device such as a system on chip (“SOC”), system on package (“SOP”), or ASIC device.

In situations in which the technology discussed here collects personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the technology described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures. For example, some embodiments of the technology can receive a candidate ad, e.g., as part of the offer specification, and can provide recommendations regarding the features of the ad based on the effectiveness of such features as defined by the effectiveness data collected or received by the technology for similar businesses, similar ads, or similar products.

1. A computer-implemented method to increase the expected effectiveness of group-buying advertisements through editing a group buying ad campaign to include at least one feature of previously run ad campaign, comprising:
receiving, by a campaign creation server, a specification for a group-buying offer;
creating, by the campaign creation server, a candidate ad campaign based on the received specification, the candidate ad campaign comprising at least one campaign feature and characterized by at least one generalized feature;
determining, by the campaign creation server, an expected effectiveness of the candidate ad campaign;
comparing, by the campaign creation server, the determined expected effectiveness of the candidate ad campaign to an aggregate effectiveness of a set of at least one previously run ad campaigns having a generalized feature in common with the candidate ad campaign;
automatically editing, by the campaign creation server, the candidate ad campaign to incorporate at least one feature of the set of at least one previously run ad campaign in response to the comparison showing that the determined expected effectiveness is less than the aggregate effectiveness; and
running, by the campaign server, the edited ad campaign in an ad display network.

2. The computer-implemented method of claim 1, wherein determining the expected effectiveness of the ad campaign comprises determining at least one of: click-through rate, lead generation, response rate, incremental sales, return on investment, requests for information, engagement with content, and impressions expected for the ad campaign.

3. The computer-implemented method of claim 1, wherein the at least one feature common to the set of at least one previously run ad campaign is a geographical focus.

4. The computer-implemented method of claim 1, wherein the at least one feature common to the set of at least one previously run ad campaigns is an amount of ad budget.

5. The computer-implemented method of claim 1, wherein the at least one feature common to the set of at least one previously run ad campaigns is an ad bidding specification.

6. The computer-implemented method of claim 1, wherein the at least one feature common to the set of at least one previously run ad campaigns is a use of at least one keyword.

7. The computer-implemented method of claim 1, wherein editing is implemented through machine learning.

8. A computer program product, comprising:
a non-transitory computer-readable storage device having computer-executable program instructions embodied thereon that when executed by a computer cause the computer to increase the expected effectiveness of group-buying advertisements through editing a group buying ad campaign to include at least one feature of previously run ad campaign, the computer-executable program instructions comprising:
computer-executable program instructions to receive, by a campaign creation server, a specification for a group-buying offer;
computer-executable program instructions to create, by the campaign creation server, a candidate ad campaign based on the received specification, the candidate ad campaign comprising at least one campaign feature, and characterized by at least one generalized feature;
computer-executable program instructions to determine, by the campaign creation server, an expected effectiveness of the candidate ad campaign;
computer-executable program instructions to compare, by the campaign creation server, the determined expected effectiveness of the candidate ad campaign to an aggregate effectiveness of a set of at least one previously run ad campaigns having a generalized feature in common with the candidate ad campaign;
computer-executable program instructions to automatically edit, by the campaign creation server, the candidate ad campaign to incorporate at least one feature of the set of a plurality of previously run ad campaigns in response to the comparison showing that the determined expected effectiveness is less than the aggregate effectiveness;
computer-executable program instructions to run, by a campaign server, the edited ad campaign in an ad display network; and
computer-executable program instructions to remarket, by the campaign server, an ad of the ad campaign.

9. The computer program product of claim 8, wherein determining the expected effectiveness of the ad campaign comprises determining at least one of: click-through rate, lead generation, response rate, incremental sales, return on investment, requests for information, engagement with content, and impressions expected for the ad campaign.

10. The computer program product of claim 8, wherein the at least one feature common to the set of at least one previously run ad campaign is a geographical focus.

11. The computer program product of claim 8, wherein the at least one feature common to the set of at least one previously run ad campaigns is an amount of ad budget.

12. The computer program product of claim 8, wherein the at least one feature common to the set of at least one previously run ad campaigns is an ad bidding specification.

13. The computer program product of claim 8, wherein the at least one feature common to the set of at least one previously run ad campaigns is a use of at least one keyword.

14. The computer program product of claim 8, wherein editing is implemented through machine learning.

15. A system to increase the expected effectiveness of group-buying advertisements through editing a group buying ad campaign to include at least one feature of previously run ad campaign, comprising:
a storage resource;
a network module; and
a processor communicatively coupled to the storage resource and the network module, wherein the processor executes application code instructions that are stored in the storage resource to cause the system to:
receive, by a campaign creation server, a specification for a group-buying offer;
create, by the campaign creation server, a candidate ad campaign based on the received specification, the candidate ad campaign comprising at least one campaign feature, and characterized by at least one generalized feature;
determine, by the campaign creation server, the expected effectiveness of the candidate ad campaign;
compare, by the campaign creation server, the determined expected effectiveness of the candidate ad campaign to an aggregate effectiveness of a set of at least one previously run ad campaigns having a generalized feature in common with the candidate ad campaign;
automatically edit, by the campaign creation server, the candidate ad campaign to incorporate at least one feature of the set of a plurality of previously run ad campaigns in response to the comparison showing that the determined expected effectiveness is less than the aggregate effectiveness;
run, by a campaign server, the edited ad campaign in an ad display network; and
remarket, by the campaign server, an ad of the ad campaign.

16. The computer-implemented method of claim 15, wherein determining the expected effectiveness of the ad campaign comprises determining at least one of: click-through rate, lead generation, response rate, incremental sales, return on investment, requests for information, engagement with content, and impressions expected for the ad campaign.

17. The computer-implemented method of claim 15, wherein the at least one feature common to the set of at least one previously run ad campaign is a geographical focus.

18. The computer-implemented method of claim 15, wherein the at least one feature common to the set of at least one previously run ad campaigns is an amount of ad budget.

19. The computer-implemented method of claim 15, wherein the at least one feature common to the set of at least one previously run ad campaigns is an ad bidding specification.

20. The computer-implemented method of claim 15, wherein the at least one feature common to the set of at least one previously run ad campaigns is a use of at least one keyword.

21. The computer-implemented method of claim 15, wherein editing is implemented through machine learning.
